(19) United States
(12) Patent Application Publication
(10) Pub. No.: US 2010/0088820 A1
(43) Pub. Date: Apr. 15, 2010

(54) USE OF DIRECTIONAL SOUND SOURCE, MEDICAL TREATMENT STATION AND MEDICAL TREATMENT ROOM

(75) Inventor: Peter Kloeffel, Nuedlingen (DE)

Correspondence Address: COLLARD & ROE, P.C., 1077 NORTHERN BOULEVARD, ROSLYN, NY, 11576, US

(73) Assignee: Fresenius Medical Care Deutschland GmbH

(21) Appl. No.: 12/448,703

(22) PCT Filed: Jan. 7, 2008
(86) PCT No.: PCT/DE2008/000005

§ 371 Date: Jul. 1, 2009

(30) Foreign Application Priority Data
Jan. 11, 2007 (DE) 10 2007 002 481.0

(51) Int. Cl. A47B 71/00; H04R 1/32; E04H 3/08

(52) U.S. Cl. 5/600; 381/150

(57) ABSTRACT

The invention relates to the use of a directional sound source, a medical treatment station and a treatment room, in which each such medical treatment station has a directional sound source assigned to it.

The invention relates to the use of a directional sound source, a medical treatment station and a medical treatment room.

Currently, acoustic data such as entertainment and/or information is transmitted to patients who spend a prolonged period of time at a certain treatment station by way of headphones worn by the patients. These headphones may be connected to a device that is assigned to the particular patient in question, for example an MP3 player, a portable CD player or the like. Alternatively, the headphones may be linked to a centralized device, with information being transmitted from the centralized device to the headphones in question by way of infrared, for example.

Particularly in situations where there are several patients in one room, the patients must wear headphones if they do not all want to hear the same program. Many patients find the wearing of headphones uncomfortable.

To solve this problem, it is suggested in this invention that, as part of a combination of media devices, a directional sound source be used in conjunction with a treatment station for a patient if the patient is to spend a prolonged period of time at this treatment station.

This might apply, for instance, in the case of a dialysis treatment or of a comparatively slow infusion, as for example in the case of chemotherapy.

The advantage for the patients is that they do not need to wear headphones but can still hear their individual program without bothering, or being bothered by, their neighbours. The program may be an audio program as such, but also a film soundtrack.

Not having to wear headphones is an advantage in so far as this is more comfortable for the patients and also because the headphone leads, which would otherwise be needed in addition to the hoses and leads connected up to the patient anyway during the treatment, are superfluous.

Accommodating several patients together in a large room has advantages with respect to medical care and treatment monitoring—acoustic separation of patients from one another, i.e. having them in separate rooms, is not feasible for medical reasons. This makes the acoustic separation of the room compartments in which, for example, the beds of the individual patients are accommodated, all the more advantageous.

Directional sound sources are already known. Reference is made especially to US 2001/0007591 A1 in this connection. There, an ultrasonic wave is used as carrier wave, being modulated appropriately for transmission of the acoustic signals. For an explanation of this technology, reference is made explicitly to this publication.

Sound sources of this kind can be procured from Holosonic Research Labs, Inc., for example.

In the embodiment according to claim 2, the treatment station is a dialyser station. This may be, in particular, a haemodialyser station.

It is to advantage here that the patients are able to hear their own individual programs comfortably during the treatment, which lasts for several hours. Depending on the state of the patient's health, this treatment must be performed up to three times weekly.

In the embodiment according to claim 3, a personalised category of information/entertainment is supplied to the patient via the directional sound source.

In addition to medical data, certain habits of the patient in respect of what he/she likes to listen to or watch can be stored, for example on a patient card or in a patient file. Classical music, for instance, can then be played without the patient having to specifically choose it during any one treatment.

Claim 4 relates to a medical treatment station consisting of a seat and/or a bed on which the patient sits or lies for a prolonged period of time during the medical treatment, there being a combination of media devices assigned to said medical treatment station, the sound output from the combination of media devices being individually assignable to said specific treatment station, and the sound output being assigned to said station by means of at least one directional sound source.

The advantages of this setup are comparable to the advantages already discussed in connection with claim 1.

In the embodiment according to claim 5, the medical treatment station is a dialyser station.

The corresponding advantages have already been discussed in connection with claim 2.

In the embodiment according to claim 6, a personalised category of information/entertainment can be supplied to the patient via the directional sound source.

The advantages have already been discussed in connection with claim 3.

Claim 8 relates to a medical treatment room, which, according to the invention, features a plurality of the previously described medical treatment stations.

The spatial confinement of the sound radiation is particularly beneficial in this case because the patients are not mutually disturbed.

Within the scope of this invention, the combination of media devices can include, besides the sound source, a base unit for providing the information and/or entertainment. This base unit can be, for instance, a playback device for sound and/or picture storage media, or also a receiver for receiving signals transmitted by cable or signals transmitted wirelessly. The combination of media devices can also include a display unit for visual presentation of the information or entertainment. The display unit can be a cathode ray tube but also a display.

In addition to the bed or seat for the patient, the treatment station according to this invention can feature therapeutic equipment. This therapeutic equipment can include, for example, a blood treatment device or an infusion device. The blood treatment device may be, in particular, a haemodialyser. It is to particular advantage here that the time during which the patient is confined to the station, i.e. for the duration of the medical treatment, can be made pleasanter and thus easier to bear.

An embodiment of the invention is shown in the drawings, where:

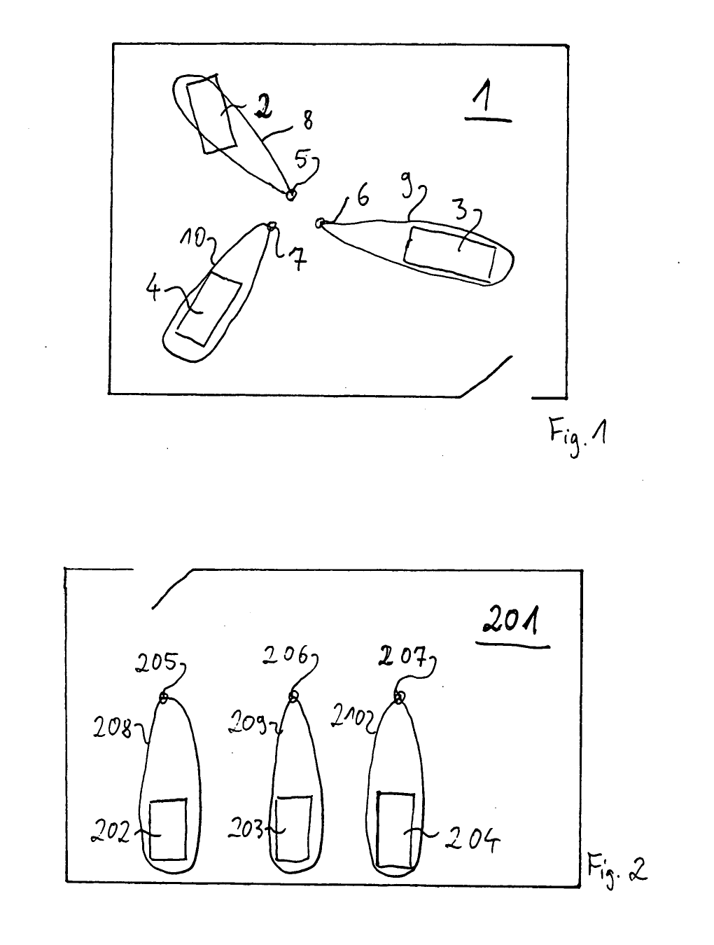

FIG. 1 illustrates a first embodiment of a medical treatment room, in which the medical treatment stations are arranged in a star-shape, and

FIG. 2 illustrates another embodiment of a medical treatment room, in which the medical treatment stations are arranged parallel to each other.

FIG. 1 illustrates a first embodiment of a medical treatment room 1, in which the medical treatment stations 2, 3 and 4 are arranged in a star-shape.

Each of the medical treatment stations 2, 3, 4 has a sound source 5, 6, 7 assigned to it, with a radiation characteristic 8, 9, 10 of such nature that one of the sound cones is assigned to each of the medical treatment stations. This is accomplished by lateral confinement of the sound propagation “cone”. The sound sources can be mounted, for instance, on the ceiling.

With respect to implementation, reference is made to the prior art already described at the beginning.

FIG. 2 shows another embodiment of a medical treatment room 201, in which the medical treatment stations 202, 203, 204 are arranged parallel to each other and, in the embodiment shown, along a side wall. Here, the sound sources 205, 206, 207 can be mounted on a rail that can likewise be mounted on the ceiling. Here too, the radiation characteristic 208, 209, 210 of each of the sound sources 205, 206, 207 is visible, which is assigned to the treatment stations 202, 203, 204 and which permits personalised perception.

1. Use of a directional sound source (5, 6, 7, 205, 206, 207) as part of a combination of media devices in conjunction with a treatment station (2, 3, 4, 202, 203, 204) for a patient, at which the patient spends a prolonged period of time.

2. Use according to claim 1,
wherein the treatment station (2, 3, 4, 202, 203, 204) is a dialyser station.

3. Use according to claim 1, wherein a personalised category of information/entertainment is supplied to the patient via the directional sound source (5, 6, 7, 205, 206, 207).

4. Medical treatment station (2, 3, 4, 202, 203, 204) consisting of a seat and/or a bed on which a patient sits or lies for a prolonged period of time during a medical treatment, there being a combination of media devices, including a sound source, assigned to said medical treatment station (2, 3, 4, 202, 203, 204), said sound source (5, 6, 7, 205, 206, 207) for the combination of media devices being individually assignable to said specific treatment station (2, 3, 4, 202, 203, 204),
wherein assignment of the sound source (5, 6, 7, 205, 206, 207) is effected by means of at least one directional sound source (5, 6, 7, 205, 206, 207).

5. Medical treatment station according to claim 4,
wherein the treatment station (2, 3, 4, 202, 203, 204) is a dialyser station.

6. Medical treatment station according to claim 4,
wherein a personalised category of information/entertainment can be supplied to the patient via the directional sound source (5, 6, 7, 205, 206, 207).

7. Medical treatment room,
wherein said medical treatment room (1, 201) features a plurality of the medical treatment stations (2, 3, 4, 202, 203, 204) according to claim 4.
